(19) United States
(12) Patent Application Publication
(10) Pub. No.: US 2010/0006736 A1
(43) Pub. Date: Jan. 14, 2010

(54) Hanger for supporting a structure from an overhead support

(76) Inventor: Todd G. Jager, Sioux City, IA (US)

Correspondence Address: THOMTE LAW OFFICE, L.L.C., 2120 S. 72ND STREET, SUITE 1111, OMAHA, NE, 68124, US

(21) Appl. No.: 12/218,008

(22) Filed: Jul. 10, 2008

(51) Int. Cl. F16M 13/00

(52) U.S. Cl. 248/562; 248/343; 248/610

(57) ABSTRACT

A hanger is described for supporting a structure from an overhead support. The hanger includes a hanger member having a U-shaped lower end with a pair of spaced-apart support legs extending upwardly therefrom for attachment to an overhead support. A bolt support is positioned in the U-shaped lower end of the hanger member and has a support bolt extending upwardly through the hanger member and the washer assembly to deflect the load in the support bolt throughout the entire curved face of the lower end of the hanger member. A modified form of the bolt support is provided which is of one-piece construction.

### BACKGROUND OF THE INVENTION

1. Field of the Invention

This invention relates to a hanger for supporting a structure from an overhead support and more particularly to a hanger which includes a support bolt extending upwardly through a bolt support positioned in the U-shaped lower end portion of a hanger member so that the weight of the supported structure is deflected throughout the entire curved face of the U-shaped lower end of the hanger member.

2. Description of the Related Art

Many types of hangers, hanger brackets, hanger rods, bolt hangers, pipe hangers, ceiling hangers, etc. have been previously provided. FIG. 1 illustrates a prior art hanger structure 10 which is secured to an overhead support 12 such as a concrete ceiling by bolt 14 or other suitable anchor members. Structure 10 includes a flat lower end 16 having a bolt opening 18 extending therethrough which receives an elongated support bolt 20 extending therethrough. Normally, a washer 22 is positioned on the support bolt 20 above lower end 16 with a nut 24 being threaded onto the support bolt 20 above the washer 22. The lower end of support bolt 20 will be secured to a structure such as a conveyor, etc. which requires overhead support. The washer 22 focuses the load carried by the support bolt 20 on the flat lower end 16 over a very small area thereof. The small support surface between the washer 22 and the flat lower end 16 will cause the flat lower end 16 to deform which may result in failure of the hanger.

### SUMMARY OF THE INVENTION

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

A hanger is disclosed for supporting a structure from an overhead support and which comprises a hanger member having a U-shaped lower end with a pair of spaced-apart support legs extending upwardly therefrom for attachment to the overhead support. The U-shaped lower end of the hanger member has a bolt opening formed therein. A bolt support having an upper end and a generally U-shaped lower end is positioned on and in engagement with the U-shaped lower end of the hanger member. The bolt support has a vertically disposed bolt opening formed therein which registers with the bolt opening in the lower end of the hanger member. An elongated support bolt, having upper and lower ends, is received by the bolt opening in the lower end of the hanger member and the bolt opening in the bolt support and is secured to the bolt support by means of a nut. The lower end of the support bolt is adapted to be secured to the structure to be supported from the overhead support. The U-shaped lower end of the bolt support deflects the load on the support bolt throughout the entire curved face of the U-shaped lower end of the hanger member.

It is therefore a principal object of the invention to provide an improved support for supporting a structure from an overhead support.

A further object of the invention is to provide a hanger of the type described which includes a bolt support or washer assembly having a generally U-shaped lower end which is positioned on an in engagement with the U-shaped lower end of the hanger member.

A further object of the invention is to provide a hanger of the type described which deflects the load of the support bolt throughout the entire curved face of the hanger member.

These and other objects will be apparent to those skilled in the art.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a side view of a prior art hanger device secured to an overhead support;

FIG. 2 is a side view of the instant invention with the hanger being secured to an overhead support;

FIG. 3 is a perspective view of the bolt support utilized in this invention;

FIG. 4 is a perspective view illustrating the hanger of this invention secured to an overhead support such as a concrete ceiling or panel;

FIG. 5 is a side elevational view the hanger member of this invention; and

FIG. 6 is a perspective view of a modified form of the bolt support of this invention.

### DESCRIPTION OF THE PREFERRED EMBODIMENT

Embodiments are described more fully below with reference to the accompanying figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense in that the scope of the present invention is defined only by the appended claims.

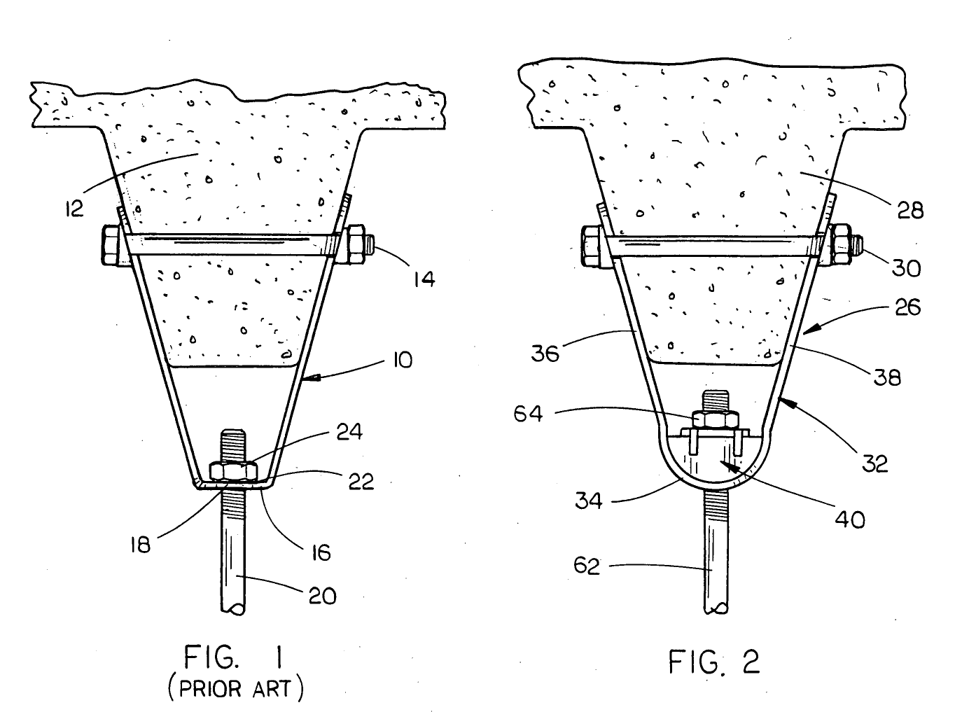

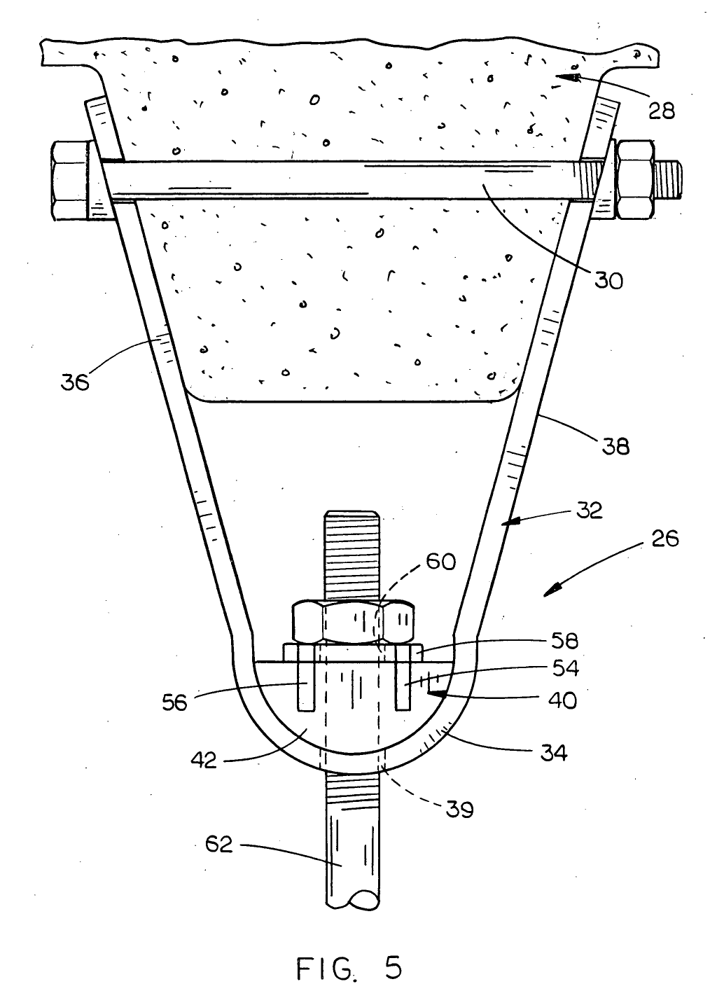

Referring to FIGS. 2-5, the hanger of this invention is referred to generally by the reference numeral 26. FIGS. 2, 4 and 5 illustrate the hanger 26 being secured to an overhead support 28 such as a concrete ceiling or panel by bolt 30 or the like. Other types of overhead supports may be utilized as well as other types of anchors being able to be utilized.

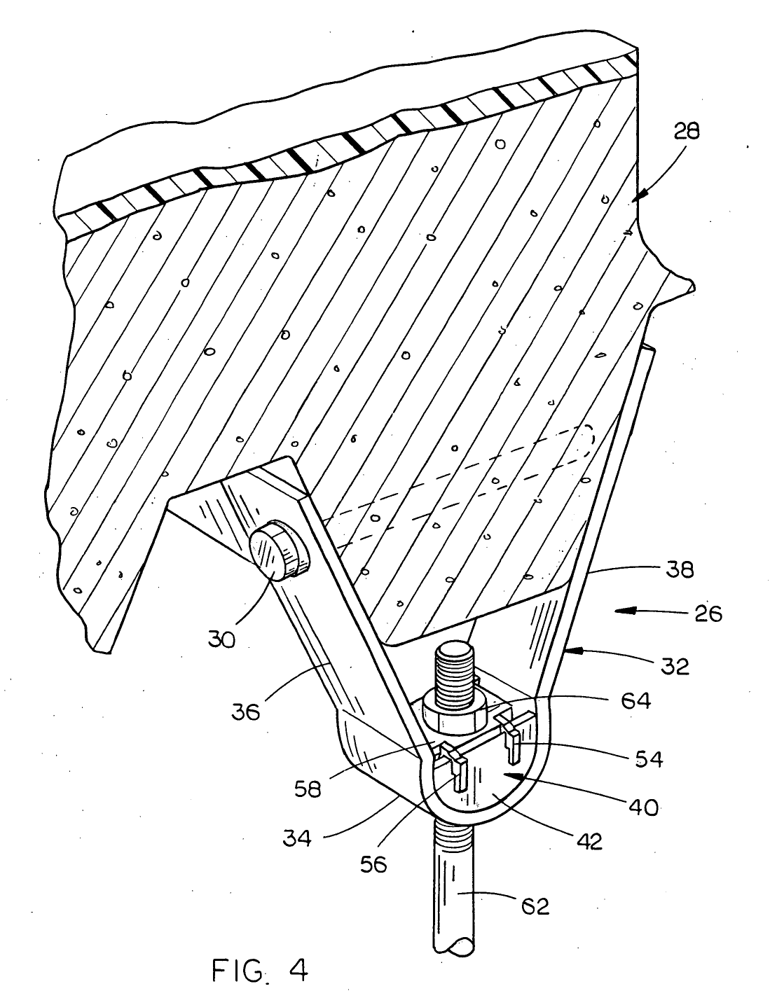

Hanger 26 includes a generally U-shaped hanger member 32 having a U-shaped lower end 34 and a pair of support legs 36 and 38 extending upwardly therefrom. Lower end 34 has a bolt opening 39 formed therein. The hanger 26 is preferably constructed of a steel material designed such that the legs 36 and 38 may be bent to conform to the configuration or shape of the overhead support. As seen in FIG. 4, hanger member 32 is constructed of a flat bar material bent to define the U-shaped lower end 34 and the support legs 36 and 38.

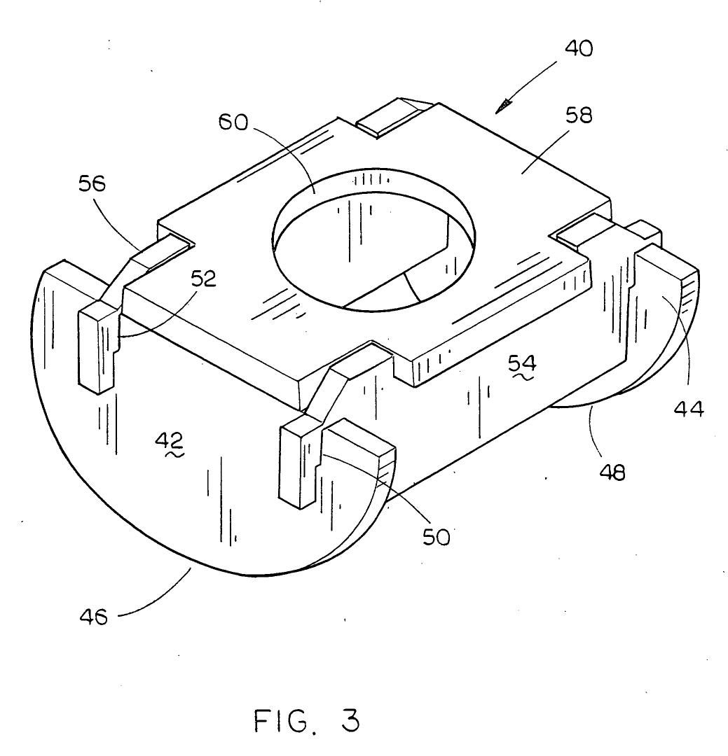

The numeral 40 refers to a bolt support or washer assembly which is best seen in FIG. 3. The washer assembly 40 includes a pair of vertically disposed and horizontally spaced-apart semi-circular discs 42 and 44 having a semi-circular lower ends 46 and 48 which are complimentary in shape to the inner surface of the lower end 34 of hanger member 32. Disc 42 is provided with a pair of notches 50 and 52 extending downwardly into the upper end thereof. Similarly, disc 44 has a pair of notches formed therein which are identical to the notches 50 and 52 in disc 42.

Washer assembly 40 includes a pair of vertically disposed and horizontally spaced-apart plates 54 and 56, the upper ends of which are received in the notches 50 and 52 and identical notches in disc 44. Plates 54 and 56 are welded to discs 42 and 44. Top plate 58 is included in the washer assembly 40 and extends across the top of the washer assembly as illustrated in FIG. 3. Top plate 58 is welded to plates 54 and 56 to maintain top plate 58 in position. Top plate 58 is provided with a bolt opening 60 formed therein.

In use, the bolt support 40 is positioned in the interior of the U-shaped lower end 34 of hanger member 32 as illustrated in FIG. 4 and the support bolt 62 is extended upwardly through bolt opening 39 and through the opening 60 in top plate 58 so that a nut 64 may be threaded onto the upper end of the support bolt 62. The load carried by the support bolt 62 is deflected throughout the entire curved face of the lower end 34 of hanger member 32 due to the engagement of the lower ends of the discs 42 and 44 with the interior surface of the lower end of the hanger member.

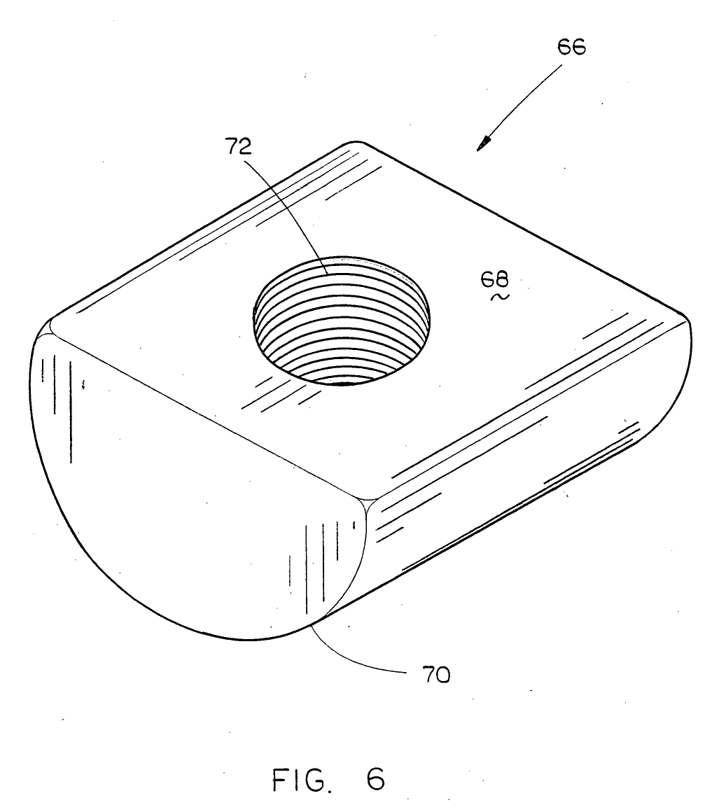

FIG. 6 illustrates a modified form of the bolt support and which is designated generally by the reference numeral 66. As seen in FIG. 6, the bolt support 66 is of one-piece construction and has a flat upper surface 68 and a semi-circular shaped lower face 70 which engages the entire inner surface of the lower end 34 of the hanger member 32. Washer assembly 66 includes an internally threaded opening 72 formed therein for threadably receiving the upper end of the support bolt 62. If the opening 72 is not internally threaded, a nut will be mounted on the upper end of the bolt 62 and will rest on the upper surface 68 of the washer assembly 66.

Thus it can be seen that in both of the embodiments disclosed herein, the load on the support bolt 62 is deflected throughout the entire curved face of the hanger member rather than the small area of the prior art hanger illustrated in FIG. 1. It can therefore be seen that the invention accomplishes at least all of its stated objectives.

Although the invention has been described in language that is specific to certain structures and methodological steps, it is to be understood that the invention defined in the appended claims is not necessarily limited to the specific structures and/or steps described. Rather, the specific aspects and steps are described as forms of implementing the claimed invention. Since many embodiments of the invention can be practiced without departing from the spirit and scope of the invention, the invention resides in the claims hereinafter appended.

1. A hanger for supporting a structure from an overhead support, comprising:
a one-piece hanger member having a U-shaped lower end with a pair of spaced-apart support legs extending upwardly therefrom for attachment to the overhead support;
said U-shaped lower end of said hanger member having a bolt opening formed therein;
a bolt support having an upper end and a generally U-shaped lower end which is positioned on and in engagement with said U-shaped lower end of said hanger member;
said bolt support being positioned between said support legs;
said bolt support having a bolt opening formed therein;
an elongated support bolt, having upper and lower ends, received by said bolt opening in said hanger member and said bolt opening in said bolt support;
a nut threaded onto said upper end of said support bolt which is supported on said upper end of said bolt support;
said lower end of said support bolt adapted to be secured to the structure to be supported from the overhead support.

2. The hanger of claim 1 wherein said bolt support comprises first and second vertically disposed and horizontally spaced, semi-circular discs having upper ends and arcuate lower ends, first and second vertically disposed and horizontally spaced plates, having upper and lower ends, secured to and extending between said first and second discs, in a transverse relationship thereto, and a top plate secured to said upper ends of said first and second discs and said first and second plates, said bolt opening in said bolt support being formed in said top plate, said arcuate lower ends of said discs being in engagement with said U-shaped lower end of said hanger member.

3. The hanger of claim 2 wherein said first and second discs and said first and second plates are welded together and wherein said top plate is welded to said first and second plates.

4. A hanger for supporting a structure from an overhead support, comprising:
a one-piece hanger member having a U-shaped lower end with a pair of spaced-apart support legs extending upwardly therefrom for attachment to the overhead support;
said U-shaped lower end of said hanger member having a bolt opening formed therein;
a bolt support having an upper end and a generally U-shaped lower end which is positioned on and in engagement with said U-shaped lower end of said hanger member;
said bolt support being positioned between said support legs;
said bolt support having a bolt opening formed therein;
an elongated support bolt, having upper and lower ends, received by said bolt opening in said hanger member and said bolt opening in said bolt support;
said upper end of said support bolt being supported by said bolt support;
said lower end of said support bolt adapted to be secured to the structure to be supported from the overhead support.

5. The hanger of claim 4 wherein said bolt support is of one-piece construction.

6. The hanger of claim 4 wherein bolt opening of said bolt support is internally threaded and wherein said upper end of said support bolt is threadably positioned in said bolt opening.
